(19) United States
(12) Patent Application Publication
(10) Pub. No.: US 2023/0415135 A1
(43) Pub. Date: Dec. 28, 2023

(54) SAPO-34 MOLECULAR SIEVE WITH SMALL CRYSTAL SIZE AND A HOLLOW STRUCTURE RAPIDLY SYNTHESIZED BY USING WASTE MTO CATALYST AND METHOD FOR PREPARATION THEREOF

(71) Applicant: CHINA UNIVERSITY OF PETROLEUM (EAST CHINA), Qingdao City (CN)

(72) Inventors: Yuchao LYU, Qingdao City (CN); Xinmei LIU, Qingdao City (CN); Yue HU, Qingdao City (CN); Xuejie SUI, Qingdao City (CN); Jianye FU, Qingdao City (CN); Zhengxing QIN, Qingdao City (CN)

(21) Appl. No.: 18/206,487

(22) Filed: Jun. 6, 2023

(30) Foreign Application Priority Data
Jun. 22, 2022 (CN) 202210711706.3

(51) Int. Cl. B01J 29/85; C01B 39/54; B01J 37/08; B01J 37/04; B01J 37/03; B01J 37/02; B01J 37/00

(52) U.S. Cl. CPC B01J 29/85; C01B 39/54; B01J 37/08; B01J 37/04; B01J 37/036; B01J 37/0236; B01J 37/0018; C01P 2002/60; C01P 2002/72; C01P 2004/03; C01P 2004/04

(57) ABSTRACT

The present invention provides a SAPO-34 molecular sieve with small crystal size and a hollow structure rapidly synthesized from a waste MTO catalyst and a method for preparation thereof. The method comprises of the following steps: calcining a waste MTO catalyst fine powder; mixing it with an inorganic acid solution to obtain a mixed solution; adding an organic amine and a phosphorus source to the mixed solution, and stirring it to obtain an initial gel mixture for SAPO-34 molecular sieve; crystallizing the initial gel mixture, and then drying the resultant to obtain a raw SAPO-34 molecular sieve powder; and calcining the raw powder obtained to obtain the SAPO-34 molecular sieve with small crystal size and a hollow structure. According to the present invention, the amount of the template may be reduced without additional silicon and aluminum sources, while the crystallization time may be shortened, so that the production cost of SAPO-34 molecular sieve may be reduced and the production efficiency may be improved.

### CROSS-REFERENCE TO RELATED APPLICATION

This application claims the benefit of Chinese Application 202210711706.3, filed Jun. 22, 2022, the contents of which are hereby incorporated in their entirety.

### FIELD OF THE INVENTION

The present invention relates to a SAPO-34 molecular sieve with small crystal size and a hollow structure which can be rapidly synthesized from a waste MTO catalyst, and also relates to a method for preparation thereof. It belongs to the field of solid waste treatment and recycling.

### BACKGROUND OF THE INVENTION

Methanol to Olefin (MTO) is a green chemical technology that has successfully achieved partial substitution of coal for crude oil to produce light olefins (mainly ethylene and propylene). As the most rapidly developing coal chemical technology in recent years, methanol to olefin (MTO) is accompanied by the generation of large amounts of waste catalysts while obtaining ethylene and propylene.

At present, a waste MTO catalyst is mainly treated by centralized burial. However, the simple burial also has the risk of pollution due to the coke contained in the waste catalyst. Thus, the use of waste catalysts directly as raw material for resource utilization can achieve pollution reduction and even hazard-free treatment while recovering the waste to the original device to realize the recycling of resources, and thus can solve the problem of insufficient capacity for hazardous waste treatment and resource shortage, which has great development potential and strategic significance. So far, researchers have worked on the resource utilization of waste MTO catalysts, but it is still in the initial stage.

The SAPO-34 molecular sieve has a medium acid strength, an excellent shape selectivity, and a high selectivity for conversing methanol to ethylene and propylene. It is an MTO catalyst of highest interest. However, it tends to deposit carbon and deactivate rapidly in MTO reaction due to the special “cage” in the structure and the inherent property as an acidic catalyst. Therefore, scientists have conducted a lot of research on the synthesis of SAPO-34 molecular sieves in the past decades, trying to find ways to improve the catalytic performance of SAPO-34. Several studies have shown that diffusion is one of the essential factors affecting the catalytic performance of SAPO-34 molecular sieves, and the reduction of the catalyst crystal size can slow down the rate of carbon deposition and extend the catalyst lifetime. This is due to the fact that a smaller crystal size will be more conducive to the diffusion of the reactant methanol and the resulting hydrocarbons out of the pore channels, reducing the carbon retention rate inside the crystal. The SAPO-34 molecular sieve with crystal size less than 100 nm, obtained by using ultrasound-assisted preparation, significantly improved the catalyst lifetime (Nishiyama N, Kawaguchi M, Hirota Y, et al. Applied Catalysis A-General, 2009, 362(1-2): 193-199). In addition, there are some findings that the introduction of hierarchical structures can effectively improve the diffusion performance of SAPO-34 molecular sieve. However, in the conventional hydrothermal system, the preparation of small crystal SAPO-34 molecular sieves still needs to be achieved with the help of expensive templates or the addition of special growth inhibitors. The synthesis of SAPO-34 molecular sieves with hierarchical structures also usually requires introducing special templates or the acid-base post-treatment. It not only increases the cost of molecular sieve synthesis but also causes severe environmental problems, which limits the industrial application of the molecular sieve.

Thus, the development of lost-cost routes for the preparation of SAPO-34 with small crystal size and a hollow structure is of great importance for industrial applications.

### SUMMARY OF THE INVENTION

Given the above technical problems, the present invention aims to provide a SAPO-34 molecular sieve with small crystal size and a hollow structure rapidly synthesized from a waste MTO catalyst and a preparation method thereof. A waste MTO catalyst is used as the raw material for synthesis in the present invention and the SAPO-34 molecular sieve with small crystal size and a hollow structure may be rapidly synthesized by adding a small amount of an inexpensive template. In the process, the amount of the template may be reduced without additional silicon and aluminum sources, while the crystallization time may be shortened. Therefore, the production cost of the SAPO-34 molecular sieve may be reduced and the production efficiency may be improved.

To achieve the above objects, the present invention first provides a method for rapidly synthesizing a SAPO-34 molecular sieve with small crystal size and a hollow structure from a waste MTO catalyst, which comprises the following steps:
(1) calcining a waste MTO catalyst fine powder;
(2) mixing the calcined catalyst fine powder with an inorganic acid solution and stirring at a certain temperature for a certain time period to obtain a mixed solution;
(3) adding an organic amine and a phosphorus source to the mixed solution obtained in step (2), and stirring at a certain temperature for a certain time period to obtain an initial gel mixture for SAPO-34 molecular sieve;
(4) crystallizing the initial gel mixture for SAPO-34 molecular sieve obtained in step (3), and then at least drying the resultant to obtain a raw SAPO-34 molecular sieve powder; and
(5) calcining the raw SAPO-34 molecular sieve powder obtained in step (4) to obtain the SAPO-34 molecular sieve with small crystal size and a hollow structure.

In the above method, preferably, the fresh catalyst corresponding to the waste MTO catalyst fine powder used in step (1) is a SAPO-34 molecular sieve; and the waste MTO catalyst fine powder has a Si/Al molar ratio of 1:(2-5), more preferably 1:(3.5-4.5). More preferably, the waste MTO catalyst fine powder has a Si/Al/P molar ratio of 1:(2-5):(1-2.5). Particularly preferably, the Si/Al/P molar ratio of the waste MTO catalyst fine powder is 1:4:1.

In the above method, preferably, the waste MTO catalyst fine powder used in step (1) is a permanently deactivated waste MTO catalyst, having no characteristic diffraction peaks of the SAPO-34 molecular sieve in its X-ray diffraction spectrum. That is, in the X-ray diffraction spectrum of the waste MTO catalyst fine powder, no characteristic diffraction peaks of the SAPO-34 framework are present at 9.6°, 12.8°, 16.2°, 21.5° and 30.9°. More preferably, the permanent deactivation of the waste MTO catalyst fine powder is achieved by exposing an incompletely deactivated waste MTO catalyst fine powder to air at room temperature for an extended period (at least three months). The incompletely deactivated waste MTO catalyst fine powder is an industrially discarded waste MTO catalyst of the SAPO-34 molecular sieve.

The permanently deactivated waste MTO catalyst is inventively used in the present invention to synthesize SAPO-34 molecular sieve with small crystal size and a hollow structure. The SAPO-34 framework in this permanently deactivated MTO catalyst collapsed, but many SAPO-34 structural fragments, such as microcrystalline structures or secondary structural units, still exist. These are equivalent to providing many nuclei during the crystallization process, which increases the supersaturated nucleus concentration in the mother liquor and slows down the growth process of crystals. Thus it enables the synthesis of molecular sieves having a small crystal size.

In the above preparation method, preferably, in step (1), the calcining in step (1) may be carried out at a temperature of 550 to 700° C. for a time period of 8 to 10 hours. A waste MTO catalyst is calcined to remove the accumulated carbon therein in the present invention.

In the above method, preferably, in step (2), the mixed solution is obtained by mixing the calcined catalyst fine powder with the inorganic acid solution and stirring at 70 to 95° C. for 4 to 10 hours. More preferably, it may be heated up by a water bath to 70 to 95° C., at a stirring speed of preferably 400 to 700 r/min.

In the above method, preferably, in step (2), the inorganic acid solution comprises an aqueous solution of one of phosphoric acid, nitric acid and hydrochloric acid, or a mixed aqueous solution of more than one of phosphoric acid, nitric acid and hydrochloric acid.

In the above method, preferably, in step (2), the inorganic acid solution has a concentration of 0.5 M to 1.5 M (i.e., mol/L). More preferably, the inorganic acid solution has a concentration of 0.5 M, 1.0 M or 1.5 M. The concentration of the inorganic acid solution refers to the total concentration of all inorganic acids in the solution.

In the above method, preferably, in step (2), the calcined catalyst fine powder and the inorganic acid solution is mixed in a ratio of 1 g:(1-10) mL.

In the above method, preferably, in step (3), the initial gel mixture for SAPO-34 molecular sieve is obtained by adding the organic amine and phosphorus source to the mixed solution obtained in step (2) and stirring at 15 to 30° C. for 2 to 8 hours, at a stirring speed of preferably 400 to 700 r/min.

In the above method, preferably, in step (3), the organic amine comprises triethylamine.

In the above method, preferably, in step (3), the phosphorus source comprises an aqueous phosphoric acid solution. More preferably, the phosphorus source comprises a 85 wt % aqueous phosphoric acid solution.

In the above method, preferably, the mass ratio of the calcined catalyst fine powder in step (2), the organic amine and phosphorus source in step (3) is 1:(0.2-3.5):(0.05-1.0). More preferably, the mass of phosphoric acid in this mass ratio is calculated in terms of the mass of a 85 wt % aqueous phosphoric acid solution. Particularly preferably, the mass ratio of the calcined MTO catalyst fine powder in step (2), the organic amine and the 85 wt % aqueous phosphoric acid solution in step (3) is 1:(0.2-0.6):(0.2-0.8). In the present invention, only a small amount of phosphorus source is added to regulate the pH of the system.

In the above method, preferably, the initial gel mixture for SAPO-34 molecular sieve obtained in step (3) has a pH of 8 to 10.

In the above method, preferably, in step (4), the crystallization is thermostatic crystallization carried out at a temperature of 180 to 200° C. for a time period of 2 to 12 hours. More preferably, the crystallization is done by transferring the initial gel mixture for SAPO-34 molecular sieve into an autoclave for crystallization with a PTFE liner and then placing the autoclave in an oven for a thermostatic crystallization under an autogenous pressure. After the crystallization is completed, the product may be allowed to cool naturally to room temperature, followed by the subsequent steps of separation, washing and drying. The separation may be done by centrifugal separation to separate out the solid products. The washing may be done with deionized water, where the solid product obtained from the separation is washed to neutral. In addition, the order of separation and washing is not particularly limited in the present invention. It is possible to perform washing followed by separation, or to perform separation after each washing. These can be conventional operations in the art.

In the above method, preferably, in step (4), the drying is carried out at a temperature of 90 to 110° C. for a time period of 6 to 12 hours.

In the above method, preferably, in step (5), the calcining is carried out at a temperature of 500 to 650° C. for a time period of 4 to 10 hours. In the present invention, the raw SAPO-34 molecular sieve powder obtained from step (4) above is calcined at high temperature to remove the organic template, thereby obtaining SAPO-34 molecular sieve with small crystal size and a hollow structure.

The waste catalysts with completely collapsed molecular sieve structure are used as the sources of silicon, aluminum and phosphorus in the method according to the present invention. It not only has low cost for the synthetic raw materials, but also can significantly reduce the amount of the template for molecular sieve synthesis and shorten the growth time of molecular sieve because waste MTO catalysts are rich in the secondary structure units of SAPO-34. Thus, significant decrease in the time required for crystallization and rapid synthesis of molecular sieve with small crystal size and a hollow structure are achieved. At the same time, the additional silicon and aluminum sources are not required in the method according to the present invention, so the synthesis cost for the molecular sieve is substantially reduced. In addition, the crystal size of the SAPO-34 molecular sieve can be easily adjusted by pre-treating waste MTO catalyst with an inorganic acid. Therefore, the production cost for the SAPO-34 molecular sieve is reduced and the production efficiency is improved in the method according to the present invention.

The SAPO-34 molecular sieve prepared by the present invention has a mesoporous and macroporous structure (i.e., the hollow structure described in the present invention), which is caused by the etching of defective parts inside the synthesized crystal by the template in the mother liquor. Due to the ratio of each raw material as defined by the present invention and the permanently deactivated waste MTO catalyst fine powder used, the SAPO-34 crystals grow attached to smaller structural units. Meanwhile, the synthesis system of the present invention is an aluminum-rich system, i.e., the aluminum content is excessive, so the growth of the crystals is prone to forming the defects present in the form of end groups. These less ordered defective parts are easily etched by the mother liquor and preferentially dissolved. That is, the strongly alkaline organic amine as a template will be slowly released into the mother liquor during the crystallization process, increasing the pH value of the mother liquor. Therefore, the structurally dense SAPO-34 molecular sieve, supposed to be well grown, is preferentially dissolved inside to form the rich mesopores and hollow structures.

The present invention provides the method for rapidly synthesizing SAPO-34 molecular sieve with small crystal size and a hollow structure from a waste MTO catalyst. The synthesis process is environmentally friendly, simple to operate, widely applicable and inexpensive, which helps to protect the environment while effectively realizing the recycling of waste resources. Moreover, the method solves the problem to regulate the grain size in the existing method for preparing the SAPO-34 molecular sieve catalyst. The method also solves the problem of long crystallization time in the synthesis of the SAPO-34 molecular sieve by the existing hydrothermal system.

The present invention also provides a SAPO-34 molecular sieve with small crystal size and a hollow structure rapidly synthesized from a waste MTO catalyst, which is prepared by the above-mentioned method.

According to specific embodiments of the present invention, preferably, the SAPO-34 molecular sieve with small crystal size and a hollow structure has an average crystal crystal size of 500 nm to 2 μm.

According to specific embodiments of the present invention, preferably, the SAPO-34 molecular sieve with small crystal size and a hollow structure has a mesoporous and macroporous structure with a mesopore size of 10 to 50 nm and a macroporous size of 50 to 200 nm.

In addition, the present invention provides use of the aforementioned SAPO-34 molecular sieve with small crystal size and a hollow structure as a catalyst in the methanol to olefin reaction.

In the above use, preferably, in the methanol to olefin reaction with the SAPO-34 molecular sieve with small crystal size and a hollow structure as a catalyst, the total yield of ethylene and propylene is more than 87.5%.

In the above application, preferably, the SAPO-34 molecular sieve with small crystal size and a hollow structure has a catalyst lifetime of 425 to 470 minutes as a catalyst in the methanol to olefin reaction.

The SAPO-34 molecular sieve sample provided by the present invention is characterized by small grain size, high specific surface area and high crystallinity (more than 78%). Most of the SAPO-34 molecular sieves synthesized in the prior art have a crystal size of 5 to 10 μm. However, The SAPO-34 molecular sieves synthesized in the present invention are all cubic in shape, and may have an average crystal size adjusted between 500 nm and 2 μm and large specific surface areas. The SAPO-34 molecular sieve catalyst of the present invention exhibits a long lifetime in the methanol to olefin reaction, and can achieve a high selectivity for light olefins (above 87.5%) in a relatively short time (30 minutes). It also can remain stable for a long time with a high reaction stability, which is significantly better than the existing industrial catalysts and is well suited for industrial scale-up applications.

### BRIEF DESCRIPTION OF THE DRAWINGS

FIG. 1 shows the X-ray diffraction spectra of the waste catalyst, the fresh catalyst, and the molecular sieve samples of Examples 1 to Example 4 and Comparative Example 1.

FIG. 2a shows a scanning electron microscope image of the molecular sieve sample of Example 1.

FIG. 2b shows a scanning electron microscope image of the molecular sieve sample of Example 2.

FIG. 2c shows a scanning electron microscope image of the molecular sieve sample of Example 3.

FIG. 2d shows a scanning electron microscope image of the molecular sieve sample of Example 4.

FIG. 2e shows a scanning electron microscope image of the molecular sieve sample of Comparative Example 1.

FIG. 3 shows a transmission electron microscopy image of the molecular sieve sample of Example 1.

### DETAILED DESCRIPTION OF THE INVENTION

The following detailed description of the technical solutions of the present invention is provided to have a clearer understanding of the technical features, objectives and beneficial effects of the present invention, but it is not to be understood as limiting the scope of the practicable scope of the present invention.

### Example 1

This example provides a SAPO-34 molecular sieve with small crystal size and a hollow structure rapidly synthesized from a waste MTO catalyst, which was prepared by the following steps:

A waste MTO catalyst fine powder was calcined at 550° C. for 8 hours to remove the accumulated carbon. 10 g of the calcined waste MTO catalyst fine powder was added to 30 mL of a nitric acid solution with a concentration of 1 M, heated and stirred in a water bath at 75° C. for 6 hours at a stirring speed of 400-700 r/min to obtain a homogeneous mixed solution. 3.37 g of triethylamine and 3 g of a 85 wt % aqueous phosphoric acid solution were added to the above solution and stirred at 20° C. for 4 hours at a stirring speed of 400-700 r/min to obtain an initial gel mixture for SAPO-34 molecular sieve. The obtained gel mixture was loaded into an autoclave with a PTFE lining, and then the autoclave was placed in an oven, heated up to 200° C. for thermostatic crystallization (200° C.) for 2 hours under an autogenous pressure and a hydrothermal condition. Then, the solid products were separated by centrifugation, repeatedly washed with deionized water to neutral, and dried in an oven at 100° C. for 6 hours to obtain a raw SAPO-34 molecular sieve powder. The raw SAPO-34 molecular sieve powder was calcined at 550° C. for 4 hours to remove the organic amine templates, so that the SAPO-34 molecular sieve (Si) with small crystal size and a hollow structure was obtained.

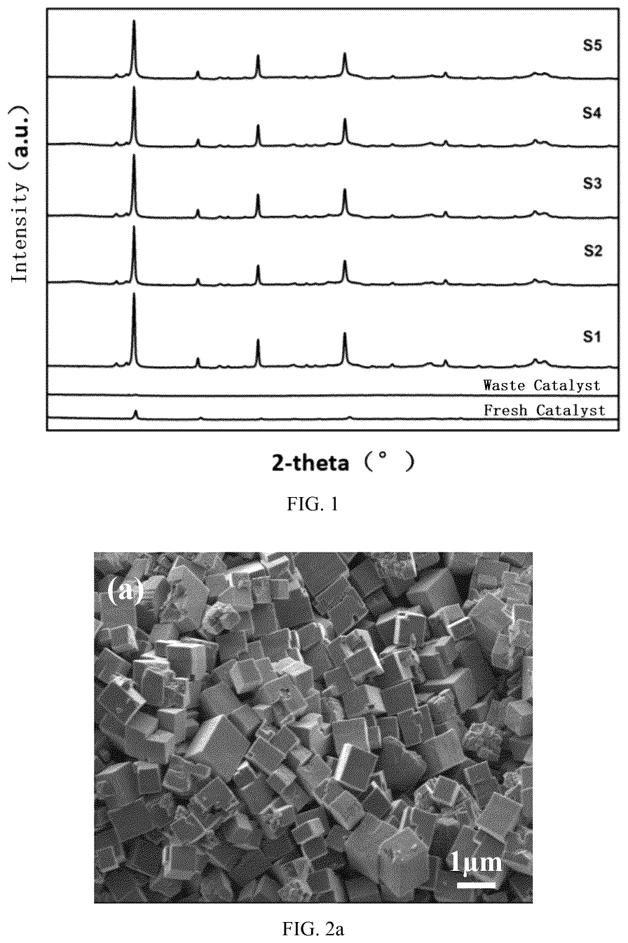

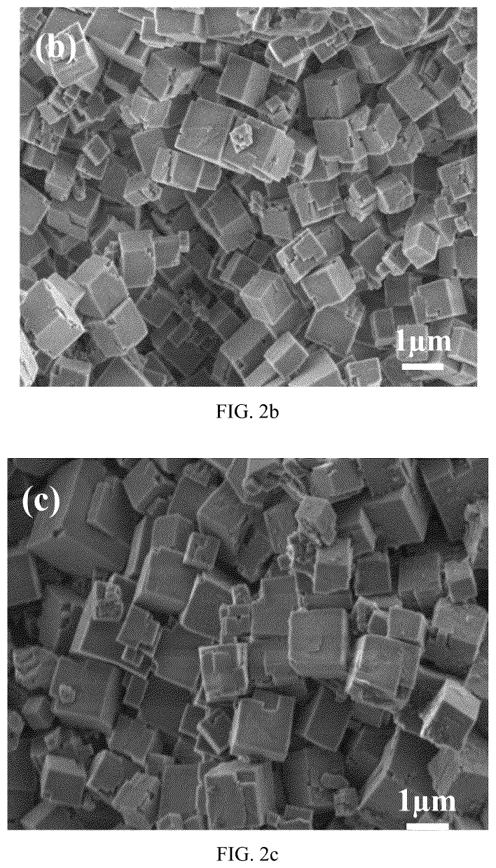

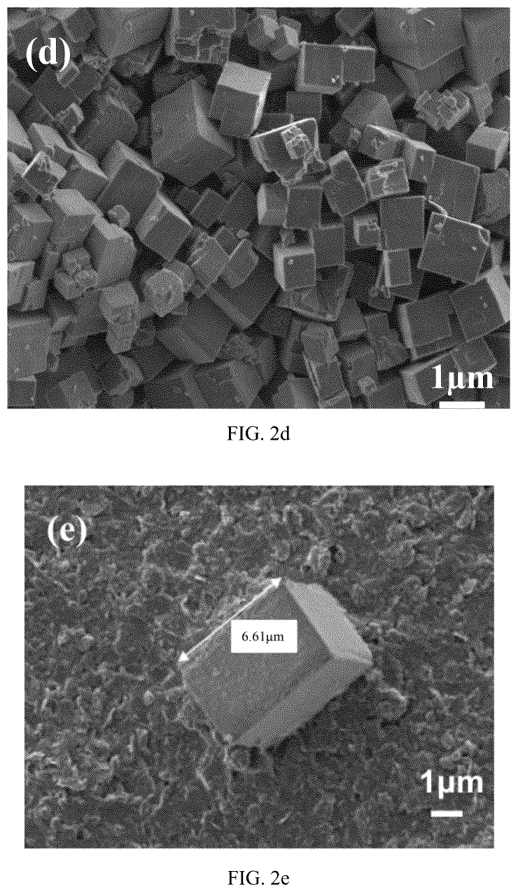

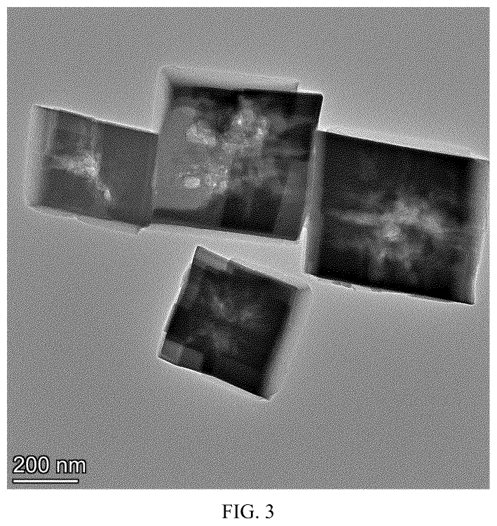

The XRD spectrum of the SAPO-34 molecular sieve (S1) with small crystal size and a hollow structure is shown in FIG. 1, and the scanning electron microscope (SEM) image is shown in FIG. 2a. It can be demonstrated that the obtained molecular sieve was a SAPO-34 molecular sieve with CHA topology, exhibiting strong characteristic diffraction peaks affiliated to the SAPO-34 skeleton at 9.6°, 12.8°, 16.2°, 21.5° and 30.9°. It has a relative crystallinity of 100% and a cubic morphology, and has an average crystal crystal size of 500 nm to 800 nm. The transmission electron microscopy (TEM) image of the SAPO-34 molecular sieve with small crystal size and a hollow structure is shown in FIG. 3. It can be seen that it had a mesoporous and macroporous structure (i.e., hollow structure) with a mesopore size of 20 to 50 nm and a macroporous size of 50 to 200 nm.

For comparison, the XRD spectra of the used waste MTO catalyst fine powders, and a fresh catalyst (which was the fresh one corresponding to the waste MTO catalyst fine powders used in this example) are also shown in FIG. 1. The used waste MTO catalyst fine powder was permanently deactivated, as shown in FIG. 1, having no characteristic diffraction peaks of SAPO-34 molecular sieve in their X-ray diffraction spectra. Namely, the characteristic diffraction peaks of the SAPO-34 framework were not present at 9.6°, 12.8°, 16.2°, 21.5° and 30.9°. The permanent deactivation of the waste MTO catalyst fine powder in this example was achieved by exposing an incompletely deactivated waste MTO catalyst fine powder in air at room temperature for 3 months. This incompletely deactivated waste MTO catalyst fine powder was an industrially discarded waste MTO catalyst of SAPO-34 molecular sieve. The Si/Al/P molar ratio of the waste MTO catalyst fine powder used in this example was 1:(3.5-4.5):(1-2.5).

### Example 2

This example provides a SAPO-34 molecular sieve with small crystal size and a hollow structure rapidly synthesized from a waste MTO catalyst, which was prepared by the following steps:

A waste MTO catalyst fine powder (the same as Example 1, which was a permanently deactivated waste MTO catalyst fine powder) was calcined at 600° C. for 10 hours to remove the accumulated carbon. 10 g of the calcined waste MTO catalyst fine powder was added to 60 mL of a nitric acid solution with a concentration of 1.5 M, heated and stirred in a water bath at 95° C. for 10 hours at a stirring speed of 400-700 r/min to obtain a homogeneous mixed solution. 4.92 g of triethylamine and 3.38 g of a 85 wt % aqueous phosphoric acid solution were added to the above solution and stirred at 20° C. for 4 hours at a stirring speed of 400-700 r/min to obtain an initial gel mixture for SAPO-34 molecular sieve. The obtained gel mixture was loaded into an autoclave with a PTFE lining, and then the autoclave was placed in an oven, heated up to 180° C. for thermostatic crystallization (180° C.) for 5 hours under an autogenous pressure and a hydrothermal condition. Then, the solid products were separated by centrifugation, repeatedly washed with deionized water to neutral, and dried in an oven at 100° C. for 8 hours to obtain a raw SAPO-34 molecular sieve powder. The raw SAPO-34 molecular sieve powder was calcined at 550° C. for 6 hours to remove the organic amine templates, so that the SAPO-34 molecular sieve (S2) with small crystal size and a hollow structure was obtained.

The XRD spectrum of the SAPO-34 molecular sieve (S2) with small crystal size and a hollow structure is shown in FIG. 1, and the scanning electron microscope (SEM) image is shown in FIG. 2b. It can be demonstrated that the obtained molecular sieve was a SAPO-34 molecular sieve with CHA topology, exhibiting strong characteristic diffraction peaks affiliated to the SAPO-34 skeleton at 9.6°, 12.8°, 16.2°, 21.5° and 30.9°. It has a relative crystallinity of 78% and a cubic morphology, and has an average crystal crystal size of 800 nm to 1 μm.

### Example 3

This example provides a SAPO-34 molecular sieve with small crystal size and a hollow structure rapidly synthesized from a waste MTO catalyst, which was prepared by the following steps:

A waste MTO catalyst fine powder (the same as Example 1, which was a permanently deactivated waste MTO catalyst fine powder) was calcined at 650° C. for 8 hours to remove the accumulated carbon. 5 g of the calcined waste MTO catalyst fine powder was added to of a nitric acid solution with a concentration of 0.5 M, heated and stirred in a water bath at 95° C. for 8 hours at a stirring speed of 400-700 r/min to obtain a homogeneous mixed solution. 1.52 g of triethylamine and 4 g of a 85 wt % aqueous phosphoric acid solution were added to the above solution and stirred at 20° C. for 4 hours at a stirring speed of 400-700 r/min to obtain an initial gel mixture for SAPO-34 molecular sieve. The obtained gel mixture was loaded into an autoclave with a PTFE lining, and then the autoclave was placed in an oven, heated up to 200° C. for thermostatic crystallization (200° C.) for 8 hours under an autogenous pressure and a hydrothermal condition. Then, the solid products were separated by centrifugation, repeatedly washed with deionized water to neutral, and dried in an oven at 100° C. for 6 hours to obtain a raw SAPO-34 molecular sieve powder. The raw SAPO-34 molecular sieve powder was calcined at 600° C. for 6 hours to remove the organic amine templates, so that the SAPO-34 molecular sieve (S3) with small crystal size and a hollow structure was obtained.

The XRD spectrum of the SAPO-34 molecular sieve (S3) with small crystal size and a hollow structure is shown in FIG. 1, and the scanning electron microscope (SEM) image is shown in FIG. 2c. It can be demonstrated that the obtained molecular sieve was a SAPO-34 molecular sieve with CHA topology, exhibiting strong characteristic diffraction peaks affiliated to the SAPO-34 skeleton at 9.6°, 12.8°, 16.2°, 21.5° and 30.9°. It has a relative crystallinity of 91% and a cubic morphology, and has an average crystal crystal size of 1 μm to 2 μm.

### Example 4

This example provides a SAPO-34 molecular sieve with small crystal size and a hollow structure rapidly synthesized from a waste MTO catalyst, which is prepared by the following steps:

A waste MTO catalyst fine powder (the same as Example 1, which was a permanently deactivated waste MTO catalyst fine powder) was calcined at 650° C. for 8 hours to remove the accumulated carbon. 20 g of the calcined waste MTO catalyst fine powder was added to of a nitric acid solution with a concentration of 1.5 M, heated and stirred in a water bath at 95° C. for 10 hours at a stirring speed of 400-700 r/min to obtain a homogeneous mixed solution. 10.42 g of triethylamine and 8.5 g of a 85 wt % aqueous phosphoric acid solution were added to the above solution and stirred at 20° C. for 6 hours at a stirring speed of 400-700 r/min to obtain an initial gel mixture for SAPO-34 molecular sieve. The obtained gel mixture was loaded into an autoclave with a PTFE lining, and then the autoclave was placed in an oven, heated up to 180° C. for thermostatic crystallization (180° C.) for 12 hours under an autogenous pressure and a hydrothermal condition. Then, the solid products were separated by centrifugation, repeatedly washed with deionized water to neutral, and dried in an oven at 100° C. for 10 hours to obtain a raw SAPO-34 molecular sieve powder. The raw SAPO-34 molecular sieve powder was calcined at 650° C. for 8 hours to remove the organic amine templates, so that the SAPO-34 molecular sieve (S4) with small crystal size and a hollow structure was obtained.

The XRD spectrum of the SAPO-34 molecular sieve (S4) with small crystal size and a hollow structure is shown in FIG. 1, and the scanning electron microscope (SEM) image is shown in FIG. 2d. It can be demonstrated that the obtained molecular sieve was a SAPO-34 molecular sieve with CHA topology, exhibiting strong characteristic diffraction peaks affiliated to the SAPO-34 skeleton at 9.6°, 12.8°, 16.2°, 21.5° and 30.9°. It has a relative crystallinity of 89% and a cubic morphology, and has an average crystal crystal size of 1 μm to 1.5 μm.

### Comparative Example 1

This comparative example provided a SAPO-34 molecular sieve, which was prepared by the following steps.

10 g of pseudoboehmite was mixed with 20 g of deionized water to obtain a homogeneous solution; 1.5 g of a 85 wt % aqueous phosphoric acid solution, 3.7 g of silica sol and 5.42 g of triethylamine were sequentially added to the above solution and stirred at 20° C. for 6 hours at a stirring speed of 400-700 r/min to obtain an initial gel mixture for SAPO-34 molecular sieve. The obtained gel mixture was loaded into an autoclave with a PTFE lining, and then the autoclave was placed in an oven, heated up to 200° C. for thermostatic crystallization (180° C.) for 12 hours under an autogenous pressure and a hydrothermal condition. Then, the solid products were separated by centrifugation, repeatedly washed with deionized water to neutral, and dried in an oven at 100° C. for 10 hours to obtain a raw SAPO-34 molecular sieve powder. The raw SAPO-34 molecular sieve powder was calcined at 550° C. for 5 hours to remove the organic amine templates, so that the SAPO-34 molecular sieve (S5) was obtained.

The XRD spectrum of the SAPO-34 molecular sieve (S5) is shown in FIG. 1, and the scanning electron microscope (SEM) image is shown in FIG. 2e. It can be demonstrated that the obtained molecular sieve was a SAPO-34 molecular sieve with CHA topology, exhibiting strong characteristic diffraction peaks affiliated to the SAPO-34 skeleton at 9.6°, 12.8°, 16.2°, 21.5° and 30.9°. It has a relative crystallinity of 84% and a cubic morphology as synthesized, and has an average crystal crystal size of 6 μm.

### Test Example 1

The physical nitrogen adsorption-desorption test were performed on the waste catalyst (which was the permanently deactivated waste MTO catalyst fines used in Examples 1-4), the fresh catalyst (which was the fresh catalyst corresponding to the waste MTO catalyst fines used in Examples 1-4), and the molecular sieve samples obtained in Examples 1-4 and Comparative Example 1, respectively, and the results are shown in Table 1.

TABLE 1

BET (m²/g)

| | | External | Total surface |
|---|---|---|---|
| Sample | Micropore area | surface area | area |
| Waste catalyst | 18 | 17 | 35 |
| Fresh catalyst | 166 | 42 | 28 |
| S1 | 440 | 32 | 472 |
| S2 | 381 | 48 | 429 |
| S3 | 312 | 55 | 367 |
| S4 | 347 | 51 | 398 |
| S5 | 405 | 20 | 425 |

It can be seen from Table 1 that the molecular sieve samples of Examples 1-4 all had high specific surface area and high external surface area, which proves that the SAPO-34 molecular sieve samples provided by the present invention had the advantages such as small grain size, high specific surface area and high crystallinity.

### Test Example 2

The molecular sieve samples of Examples 1-4 were evaluated for MTO catalyst performance using a fixed-bed catalytic reaction device for evaluation. First, 1.0 g of the above four samples were weighed and placed into the reactor respectively, and activated by introducing nitrogen gas at 550° C. for 2 hours, and then cooled down to 470° C. The feed methanol was carried by nitrogen at an air speed of 2 h⁻¹ and the reaction products were analyzed online using gas chromatography Agilent 6820 and Agilent 7820 at 15 min intervals. The reaction was terminated when the methanol conversion rate was below 100%, i.e., when the components of methanol and dimethyl ether appeared in the GC Agilent 6820 spectrum. After the reaction, the liquid products were collected in an ice and water bath and the gaseous products were discharged through the tail gas duct.

The catalyst of SAPO-34 molecular sieve (S1) with small crystal size and a hollow structure of Example 1 was tested to have a selectivity for ethylene & propylene of 87.5% and a catalyst lifetime of 470 minutes. The catalyst of SAPO-34 molecular sieve (S2) with small crystal size and a hollow structure of Example 2 had a selectivity for ethylene & propylene of 88% and a catalytic lifetime of 455 minutes. The catalyst of SAPO-34 molecular sieve (S3) with small crystal size and a hollow structure of Example 3 had a selectivity for ethylene and propylene of 87.8% and a catalyst lifetime of 430 minutes. The catalyst of SAPO-34 molecular sieve (S4) with small crystal size and a hollow structure of Example 4 had a selectivity for ethylene and propylene of 87.6% and a catalyst lifetime of 425 minutes.

What is claimed is:

1. A method for rapidly synthesizing a SAPO-34 molecular sieve with small crystal size and a hollow structure from a waste MTO catalyst, comprising the following steps:
(1) calcining a waste MTO catalyst fine powder;
(2) mixing the calcined catalyst fine powder with an inorganic acid solution and stirring at a certain temperature for a certain time period to obtain a mixed solution;
(3) adding an organic amine and a phosphorus source to the mixed solution obtained in step (2), and stirring at a certain temperature for a certain time period to obtain an initial gel mixture for SAPO-34 molecular sieve;
(4) crystallizing the initial gel mixture for SAPO-34 molecular sieve obtained in step (3), and then at least drying the resultant to obtain a raw SAPO-34 molecular sieve powder; and
(5) calcining the raw SAPO-34 molecular sieve powder obtained in step (4) to obtain the SAPO-34 molecular sieve with small crystal size and a hollow structure.

2. The method according to claim 1, wherein a fresh catalyst corresponding to the waste MTO catalyst fine powder used in step (1) is a SAPO-34 molecular sieve; and
the waste MTO catalyst fine powder used in step (1) is a permanently deactivated waste MTO catalyst, having no characteristic diffraction peaks of SAPO-34 molecular sieve in its X-ray diffraction spectrum.

3. The method according to claim 1, wherein the calcining in step (1) is carried out at a temperature of 550 to 700° C. for a time period of 8 to 10 hours.

4. The method according to claim 1, wherein in step (2), the mixed solution is obtained by mixing the calcined catalyst fine powder with the inorganic acid solution and stirring at to 95° C. for 4 to 10 hours.

5. The method according to claim 1, wherein in step (2), the inorganic acid solution comprises an aqueous solution of one of phosphoric acid, nitric acid and hydrochloric acid, or a mixed aqueous solution of more than one of phosphoric acid, nitric acid and hydrochloric acid.

6. The method according to claim 1, wherein in step (2), the inorganic acid solution has a concentration of 0.5 M to 1.5 M.

7. The method according to claim 6, wherein in step (2), the inorganic acid solution has a concentration of 0.5 M, 1.0 M or 1.5 M.

8. The method according to claim 1, wherein in step (2), the calcined catalyst fine powder and the inorganic acid solution are mixed in a ratio of 1 g:(1-10) mL.

9. The method according to claim 1, wherein in step (3), the initial gel mixture for SAPO-34 molecular sieve is obtained by adding the organic amine and phosphorus source to the mixed solution obtained in step (2) and stirring at 15 to 30° C. for 2 to 8 hours.

10. The method according to claim 1, wherein in step (3), the organic amine comprises triethylamine.

11. The method according to claim 1, wherein in step (3), the phosphorus source comprises an aqueous phosphoric acid solution.

12. The method according to claim 11, wherein in step (3), the phosphorus source comprises a 85 wt. % aqueous phosphoric acid solution.

13. The method according to claim 1, wherein the mass ratio of the calcined catalyst fine powder in step (2), the organic amine and the phosphorus source in step (3) is 1:(0.2-3.5):(0.05-1.0).

14. The method according to claim 1, wherein the initial gel mixture for SAPO-34 molecular sieve obtained in step (3) has a pH of 8 to 10.

15. The method according to claim 1, wherein in step (4), the crystallization is thermostatic crystallization carried out at a temperature of 180 to 200° C. for a time period of 2 to 12 hours.

16. The method according to claim 1, wherein in step (4), the drying is carried out at a temperature of 90 to 110° C. for a time period of 6 to 12 hours.

17. The method according to claim 1, wherein in step (5), the calcining is carried out at a temperature of 500 to 650° C. for a time period of 4 to 10 hours.

18. A SAPO-34 molecular sieve with small crystal size and a hollow structure rapidly synthesized from a waste MTO catalyst, obtained by the method according to claim 1.

19. The SAPO-34 molecular sieve with small crystal size and a hollow structure according to claim 18, wherein the SAPO-34 molecular sieve with small crystal size and a hollow structure has an average crystal size of 500 nm to 2 nm, and has a mesoporous and macroporous structure.
